(19) United States
(12) Patent Application Publication
(10) Pub. No.: US 2005/0047779 A1
(43) Pub. Date: Mar. 3, 2005

(54) Post-detection, fiber optic dispersion compensation using adjustable inverse distortion operator employing trained or decision-based parameter adaptation (estimation)

(75) Inventors: Lonnie Scott Jaynes, Melbourne, FL (US); Jerry Busby Wood, Melbourne, FL (US)

Correspondence Address: Allen, Dyer, Doppelt, Milbrath & Gilchrist, P.A.;1401 Citrus Center, 255 South Orange Avenue, Post Office Box 3791, Orlando, FL, 32802-3791, US

(73) Assignee: HARRIS CORPORATION, MELBOURNE, FL (US)

(21) Appl. No.: 10/653,316

(22) Filed: Sep. 2, 2003

(51) Int. Cl. H04B 10/08

(52) U.S. Cl. 398/29

(57) ABSTRACT

An adaptive system composed of an adjustable inverse distortion operator or structure compensates for dispersive distortion in a fiber optic channel. Parameters of the inverse distortion operator are automatically estimated and updated in accordance with minimizing some cost function of an error signal obtained by differentially combining the output of the inverse distortion operator with downstream decision values or with an undistorted training signal. Undistorted training signals may be derived from bit patterns (e.g., preamble) expressly transmitted for the purpose of adjusting the compensation system or from other non-training patterns known to be embedded in the received signal from the transmitter.

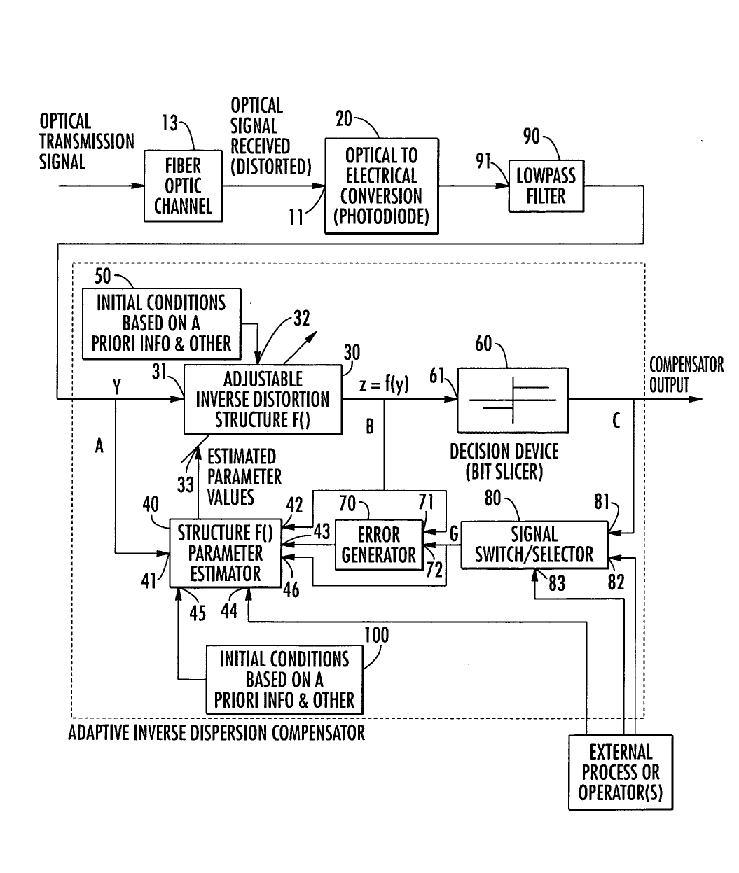

### FIELD OF THE INVENTION

The present invention relates in general to communication systems and subsystems, and is particularly directed to a method and an apparatus for compensating for dispersive distortion in a communication channel, particularly a fiber optic channel, by means of an adaptive system composed of an adjustable inverse distortion operator or structure that is installed in an electrical signal processing path of an opto-electronic receiver, wherein the parameters of the inverse distortion operator are automatically estimated and updated in accordance with an error signal obtained by differentially combining the output of the inverse distortion operator with downstream decision values or with an undistorted training signal.

### BACKGROUND OF THE INVENTION

A number of communication networks and systems, such as, but not limited to high data rate fiber optic communication systems, employ communication channels that are dispersive—in that they cause the energy of a respective signal component to be dispersed or spread in time as it is transported over the channel. In an effort to reduce the effects of dispersion, some fiber optic systems predistort the signal in a manner that is intended to be “complementary” to the effect of the optical channel, so that “optimally” at the receiver the original signal, prior to the predistortion operation, may be recovered. Other systems address the problem by dealing directly with the channel itself, such as by using dispersion compensating fibers (DCFs). These approaches can be difficult or expensive to apply under various conditions and, from a functional and architectural standpoint, are relatively rigid, so that they tend to be easily affected by operational changes or by environmental changes, such as mechanical vibration or variations in temperature. In addition, the desire to use channel multiplexing (e.g., wavelength division multiplexing (WDM)) in fiber optic cables, increased data rates, and longer uninterrupted cable lengths complicate and exacerbate the deficiencies of traditional compensation schemes.

### SUMMARY OF THE INVENTION

In accordance with the present invention, problems of conventional methodologies for dealing with channel dispersion in a. high data rate fiber optic communication system, such as those described above, are effectively obviated by means of a post-detection adaptive system composed of an adjustable inverse distortion operator or structure that is inserted in the electrical signal processing path of the output of an opto-electronic converter or detector, wherein the parameters of the inverse distortion operator are automatically estimated and updated in accordance with minimizing some cost function of an error signal obtained by differentially combining the output of the inverse distortion operator with downstream decision values for a “decision-based” parameter estimation or adaptation mode, or with an undistorted training signal for a “trained” parameter estimation or adaptation mode.

In the decision-based adaptation mode, parameter values are estimated based upon an error signal formed between the output of the inverse distortion structure and the output of a bit slicer (binary decision device) that is coupled to the output of the structure. An error generator performs a prescribed differential combining operation on its two inputs and supplies an error signal to a parameter estimation unit that is representative of the difference, dissimilarity, or variance between structure-processed data and decisions produced by the bit slicer. In this mode, parameter estimates for the inverse distortion structure (operator) can be updated on a continuous basis as data is received and processed by enabling a parameter estimation process realized or contained inside the parameter estimation unit. The onset time and duration of estimation processing is determined by the value of an estimator control signal (enable/disable/type) generated by a process or operator external to the compensator and coupled to the estimation unit.

In the trained adaptation mode, parameter values are estimated based upon an error signal formed between the output of the inverse distortion operator and a corresponding but undistorted training signal, both of which are supplied to the error generator. In the trained adaptation mode, training signals are derived either from patterns expressly transmitted for the purpose by the upstream transmitter or from other known or predictable patterns not explicitly transmitted for compensator adjustment or adaptation. As in the decision-based adaptation mode, the estimator control signal is used to enable/disable (or gate) the parameter estimation (update) process. In trained adaptation mode, activation and deactivation of the parameter update process is synchronized with the detection and availability of training signal data. Training signal data (undistorted) is generated by an external process or operator and is time-aligned with corresponding data received and processed by the compensator.

In addition to using one of the modes described above exclusively, the invention may apply both parameter estimation modes together (and possibly others), with each mode being activated over different time intervals under the control of an external process or operator. In this combined mode of operation, structure parameter estimates can be updated according to range of different criteria and schedules depending on the type and quality of data available so as to optimize overall compensator performance.

### DESCRIPTION OF THE DRAWINGS

The single Figure diagrammatically illustrates a preferred, but non-limiting embodiment of the adaptive inverse distortion compensator and parameter estimation mechanisms of the present invention.

### DETAILED DESCRIPTION

Before describing in detail the adaptive inverse distortion compensation method and system of the present invention, it should be observed that the invention resides primarily in prescribed modular arrangements of conventional digital communication circuits and associated digital signal processing components and attendant supervisory control circuitry therefor, that controls the operations of such circuits and components. In a practical implementation that facilitates their being packaged in a hardware-efficient equipment configuration, these modular arrangements may be readily implemented in different combinations of field programmable gate arrays (FPGAs), application specific integrated circuit (ASIC) chip sets, microwave/millimeter-wave monolithic integrated circuits (MIMICs), and digital signal processing (DSP) cores.

Consequently, the configuration of such arrangements of circuits and components and the manner in which they are interfaced with other communication equipment have been illustrated in the drawings by a readily understandable block diagram, which shows only those specific details that are pertinent to the present invention, so as not to obscure the disclosure with details which will be readily apparent to those skilled in the art having the benefit of the description herein. Thus, the block diagram illustration is primarily intended to show the major components of the invention in a convenient functional grouping, whereby the present invention may be more readily understood.

Attention is now directed to the single Figure, wherein a preferred, but non-limiting, embodiment of the present invention is diagrammatically illustrated as comprising an input port 11, to which an optical communication signal, such as that transported over a dispersive optical fiber 13, is coupled. As a non-limiting example, the optical communication signal may comprise a conventional synchronous optical network (SONET)-based signal, such as the SONET STS-192 signal, which contains 384 frame synchronization bytes (a priori known) in each 125-microsecond time interval (192 A1 octets and 192 A2 octets).

Input port 11, consisting of a suitable optical coupler (not shown), is coupled to an opto-electronic receiver unit, such as a photodiode detector 20, which converts the received optical communication signal into an electrical signal. This electrical signal is representative of the optical communication signal as received from the dispersive optical fiber and, as such, contains both the desired but unknown information signal component as well as auxiliary known information, such as framing components of the optical communication signal, as well as any (dispersive) distortion that has been introduced into the optical communication signal as a result of its transport over the fiber optic channel 13.

The output of the photodiode 20 is coupled to the input port 91 of a lowpass filter 90. The lowpass filter is used to suppress undesirable out-of-band (high-frequency) components present in the photodiode output signal. The output of the lowpass filter 90 is coupled to an input port 31 of a controllably adjustable inverse distortion structure or operator 30 and to an input port 41 of a parameter estimation unit 40. The inverse distortion structure is a parameterized operator designed to implement an approximate inverse function of one or more prescribed distortion mechanisms to which the optical signal is subjected as it is propagated over the fiber optic channel. Example fiber optic distortions of interest include chromatic dispersion (CD) and polarization mode dispersion (PMD). CD has a frequency response that can be represented by the transfer function H(f)=exp{−j*k*f**2}, where f is the cyclic frequency (cycles/second), j is the imaginary unit, and k is a coefficient or parameter of dispersion. As a result, an inverse distortion structure for CD could be implemented as an operator designed to approximate the transfer characteristic Hinv(f)=exp{j*k*f**2}, where unknown values of parameter k are to be estimated and adjusted by the parameter estimation process of the compensator. First order PMD can be modeled as a two-component, signal multipath process. For example, first order PMD can be represented in the time domain by the expression y(t)=gamma*x(t−t0)+(1-gamma)*x(t−t0−t1), where y(t) is the received (electrical) signal, x(t) is the signal transmitted over the PMD channel, gamma is a signal (amplitude) splitting ratio, and t1 the time delay difference between received multipath signal (polarization) components. Parameters gamma and t1 are normally variable over location and time. In this case, a suitable inverse distortion structure could be implemented as a filter (possibly requiring stabilization) whose transfer characteristic approximates the inverse of the one implied for PMD above with parameters gamma and t1. Similar to the inverse CD case previously described, unknown values for parameters gamma and t1 would be estimated and supplied by the parameter estimation process of the compensator. It should be noted that actual parameters to be estimated by the parameter estimation unit might ultimately depend upon, to some extent, the specific structure selected to approximate the inverse distortion process. For example, the inverse distortion structure may require estimates for functions of distortion parameters instead of the parameters themselves. Under ideal conditions, the inverse distortion operator 30 might be expected to completely remove targeted distortion effects imparted on the transmitted signal as a result of its propagating the FO channel. In reality though, since parameter estimates and the inverse distortion structure of the compensator are approximations, complete distortion elimination would not normally be expected. However, the invention is designed to significantly reduce signal distortion by taking advantage of a priori knowledge about the form of the distortion and by including a mechanism to automatically find and track changing or unknown distortion parameter values.

The adjustable inverse distortion operator 30 is coupled to an associated memory 50, which holds and supplies to the operator initial values based upon a priori knowledge of channel distortion characteristics as well as other initializing data. The inverse distortion operator 30 has its output coupled to a (binary) decision device or bit slicer 60, the output of which delivers the detected data stream with distortion compensation. The output of the inverse distortion operator is additionally coupled to the structure parameter estimator unit 40 and to the first input port 71 of an error generator unit 70. Error generator 70 has a second input port 72 coupled to the output of a signal switch/selector unit 80. Signal switch 80 connects one of its two input ports, 81 or 82, with its output port according to predefined signal values appearing on its switch control input port 83.

The training signal is a prescribed pattern that is known to the compensator, and may comprise a training preamble that is transmitted from the upstream transmitter at predefined intervals. A copy of this training signal is stored in the compensator (or accompanying receiving system) and can be used during or after a time the signal is transmitted by the transmitter to adjust or adapt parameter estimates of the compensator's inverse distortion structure according to current or prevailing channel conditions. The signal used in this regard by the compensator need not be a training signal as such, however. It may correspond to some other a priori known or predictable bit pattern that is transmitted by the transmitter.

As a non-limiting example, such a priori known bit patterns may correspond to the consecutive frame synchronization patterns or octets that occur in SONET data, referenced above. In order to take advantage of such data for compensator training purposes, frame synchronization octets would first be detected in the received data stream (or some derivative thereof) and then time-aligned or synchronized with undistorted versions of the synchronization octet patterns. Synchronized distorted and undistorted versions of signals based on the detected synchronization patterns could then be processed by the parameter estimation unit 40 and the error generator 70 (through the signal selector 80) at process-determined times to update inverse distortion parameter values. This process of detecting and synchronizing known signal patterns for the purpose of automatically adjusting or adapting compensator/equalizer coefficients (parameters) is of the type described in our co-pending U.S. patent application Ser. No. 10/462,559, filed on Jun. 16, 2003, entitled: “Updating Adaptive Equalizer Coefficients Using Known or Predictable Bit Patterns Distributed Among Unknown Data” (hereinafter referred to as the '559 application, assigned to the assignee of the present application and the disclosure of which is incorporated herein.

Relative to the present invention, training signals (undistorted) and associated control (“gating”) signals are generated by an external process or operator (perhaps similar to the one described in application xxx) and coupled to input port 82 of the signal switch 80 and input port 44 of the parameter estimation unit 40, respectively. Received signals containing corresponding channel-distorted patterns useful for parameter estimation are coupled to input port 41 of the parameter estimation unit and to input port 31 of the inverse distortion structure 30. Control signals are synchronized with the occurrence of detected training patterns and are used to gate the operation of the parameter estimation unit. Under the control of a “selection” signal coupled to input port 83 of the signal switch, undistorted training signals are connected to input port 72 of the error generator and input port 46 of the parameter estimator unit. It is important to note that different levels of buffering or delay (not shown in figure) may be required along signal paths A, B, and C in order to achieve proper compensator operation. These required buffers or delays could be incorporated in selected compensator components such as the parameter estimation unit, error generator, and signal switch.

Error generator 70 differentially combines signals present on its input ports 71 and 72 and places the resulting error signal (a difference, dissimilarity, or variance signal) on its output port that is coupled to the error input port 43 of the parameter estimator unit 40. Parameter estimator unit 40 is coupled to an associated memory 100, which holds and supplies to the unit initial values based upon a priori knowledge of channel distortion characteristics as well as other initializing data. The parameter estimator unit implements or contains an algorithm or operator designed to find parameter values for the inverse distortion structure that minimize some cost function (or expectation of some cost function) of the error signal. Example cost functions include squared error, absolute error, and uniform error. Signals coupled to input ports 42 and 46 of the parameter estimator unit could be used as an alternative to the direct error signal coupled to input port 43. Also, depending on the specific algorithm or operator employed and in addition to the error signal, the parameter estimator may require as input the input signal of the inverse distortion structure 30. This signal is coupled to input port 41 of the parameter estimation unit. The estimator unit generates updated parameter values for the adjustable inverse distortion structure whenever the unit is activated by an estimator control signal coupled to input port 44. Control of the parameter estimation process may be done in accordance with different criteria including the successful detection and availability of suitable compensator training patterns. With sufficient internal buffering included on input data paths, the parameter estimator unit can be designed or configured to update parameter values at rates lower than the filtering rate of the inverse distortion structure itself. This partial decoupling of structure filtering and structure parameter estimation improves the compensator's flexibility and eases overall implementation considerations. Additionally, the parameter estimator unit may contain special functions or operators for “whitening” or synthesizing new data from raw input signal data that is better suited for estimation processing.

In the decision-based parameter adaptation (or estimation) mode, structure parameter values are estimated and updated in accordance with output decisions from decision device 60. This mode is entered by selecting decision device 60 output via signal switch 80 and enabling the parameter estimation unit 40 using a control signal coupled to its input port 44. In the trained parameter adaptation (or estimation) mode, structure parameter values are estimated and updated in accordance to known signal patterns. This mode is entered by using signal switch 80 to select a known “training” signal (undistorted) coupled to input port 82 and by enabling the parameter estimation unit as before. In this mode of operation, the estimator control signal is used to enable/disable the operation of the parameter estimation unit 40 according to different criteria including the occurrence (or availability) and duration of training signal data. As described above, training signals may be composed of bit patterns transmitted expressly for the purpose of adjusting compensator parameters to existing channel conditions or they may be composed of other bit patterns known to occur in the received data stream, such as the frame synchronization octets of SONET.

The inverse distortion operator parameter update mechanism of the present invention operates as follows for its respective decision-based and trained adaptation modes.

Decision-based Parameter Adaptation (Estimation) Mode

As pointed out briefly above, in this mode of operation parameter estimates are based upon a comparison of the output of the inverse distortion structure 30 with the output of the binary decision device 60. As an electrical signal is output from the photodiode detector 20 it is coupled to the lowpass filter 90. The output of the lowpass filter is coupled to the adjustable inverse distortion structure 30. The output of the inverse distortion structure is coupled to the binary decision device 60 and to the first input port 71 of the error generator 70. The output of the decision device is coupled to the error generator through the signal switch/selector 80. Note that in the decision-based adaptation mode, the signal switch connects the output of the binary decision device to the second input port 72 of the error generator. In the trained adaptation mode, the signal switch connects an externally generated training signal (undistorted) to input port 72 of the error generator. The error generator differentially combines the signals coupled to its input ports and supplies an error signal to the parameter estimation unit 40. The parameter estimation unit implements or embodies an algorithm or operator designed to minimize some cost function of the error signal. Depending on the specific estimation process employed, the parameter estimation unit may also require as input, the input signal of the inverse distortion structure. In this estimation mode, parameter values can be updated more or less continuously by simply enabling the parameter estimator unit with the estimator control signal coupled to input port 44. The estimator control signal is generated by an external process or operator and may be used to disable the estimation process under different conditions including the reception of poor or unusable data.

Trained Parameter Adaptation (Estimation) Mode

As pointed out above, in this mode of operation parameter estimates are based upon a comparison of the output of the inverse distortion structure 30, which is coupled to the first input port 71 of error generator 70, with an undistorted training signal coupled to the second input port 72 of the error generator and supplied through the signal switch 80 from its input port 82. In this mode of operation, an external process or operator identifies the occurrence of known bit patterns in the received data stream and generates training signals based on undistorted versions of these patterns along with a corresponding synchronized “gating” signal (estimator control signal) and supplies these signals to input port 82 of the signal switch and input port 44 of the parameter estimator unit 40, respectively. The estimator control signal is used to enable/disable or “gate” the operation of the estimator unit in-accordance with different criteria including the occurrence and/or availability of training data. Known bit patterns embedded in the received data stream may correspond to patterns transmitted for the express purpose of adjusting or adapting the compensator or they may correspond to other patterns known to occur in the data stream, such as the frame synchronization octets of SONET.

Combined and Other Adaptation Modes

It should be noted that other parameter adaptation modes can be defined for the compensator in addition to the baseline types described above. For example, a “blind parameter adaptation” mode can be established for the compensator by including or implementing a process in the parameter estimator unit that does not make use of independent reference signals such as training signals. Instead, parameter values are estimated based upon measured or derived quantities (for example, statistics) of selected signals such as the input signal of the compensator. Blind parameter adaptation or estimation would be activated in a manner similar to that. of other adaptation modes using the estimator control signal to enable the parameter estimator unit and to select the appropriate estimation process.

In addition to using one of the adaptation modes described above on an exclusive basis, the present invention can be applied to take advantage of combining two or more parameter adaptation modes operating together, with each being activated at different times under the control or supervision of an external process or operator. In this combined mode of operation, an external process or operator controls or supervises the mix and durations of decision-based, trained and other adaptation through the use of the compensator's signal switch/select and estimator control signals. Combined mode (or multimode) operation provides a mechanism for optimizing compensator performance over a wide range of operating conditions.

While we have shown and described several embodiments in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

1. For use with a system for processing a communication signal that has been transported over a dispersive communication channel, so as to recover an unknown information signal contained in said communication signal, wherein said communication signal is represented as an electrical communication signal, a method of processing said electrical communication signal comprising the steps of:
(a) subjecting said electrical communication signal to an adjustable inverse distortion operator to produce a channel distortion-compensated output signal; and
(b) estimating and updating one or more parameter values of said inverse distortion operator by processing said channel distortion-compensated output signal with at least one of
the output of a decision operator to which said channel distortion-compensated output signal is coupled, said decision operator being operative to produce an output data stream in accordance with prescribed decision criteria applied to said channel distortion-compensated output signal,
an undistorted version of a known signal pattern contained in said communication signal, and
prescribed statistics or other quantities of one or more system signals.

2. The method according to claim 1, wherein step (b) comprises updating parameter estimates of said inverse distortion operator by processing said channel distortion-compensated output signal and the output of said decision operator.

3. The method according to claim 2, wherein step (b) comprises generating estimates of parameters of said adjustable inverse distortion operator by combining said channel distortion-compensated output signal and the output of said decision operator to produce an error signal and coupling said error signal to a parameter estimate generator for said inverse distortion operator.

4. The method according to claim 1, wherein step (b) comprises updating parameter estimates of said adjustable inverse distortion operator by processing said channel distortion-compensated output signal and an undistorted version of a known signal pattern contained in said communication signal.

5. The method according to claim 4, wherein step (b) comprises updating parameter estimates of said adjustable inverse distortion operator by combining channel distortion-compensated output signal and an undistorted version of a known signal pattern contained in said communication signal to produce an error signal and coupling said error signal to a parameter estimate generator for said adjustable inverse distortion operator.

6. The method according to claim 1, wherein said known signal pattern comprises a frame synchronization pattern.

7. The method according to claim 1, wherein step (b) comprises subjecting said channel distortion-compensated output signal and said at least one of the output of said decision operator and said undistorted version of a known signal pattern contained in said communication signal to a prescribed synthesis operator to produce synthesized versions thereof, and processing said synthesized versions to update parameter estimates of said adjustable inverse distortion operator.

8. The method according to claim 1, wherein step (b) comprises updating parameter values of said inverse distortion operator in accordance with said prescribed statistics or other quantities of one or more system signals.

9. The method according to claim 8, wherein step (b) comprises updating parameter values of said inverse distortion operator in accordance with prescribed statistics or other quantities of said electrical communication signal.

10. A receiver apparatus for processing a communication signal that has been transported over a dispersive communication channel, and recovering therefrom an unknown information signal contained in said communication signal, wherein said communication signal is represented as an electrical communication signal, said receiver apparatus comprising:
an adjustable inverse distortion operator coupled to subject said electrical communication signal having a transfer function or characteristic that is effectively complementary to a distortion-introducing characteristic of said channel to produce a channel distortion-compensated output signal; and
a parameter estimate update mechanism, which is operative to update parameter estimates of said adjustable inverse distortion operator by processing said channel distortion-compensated output signal with at least one of
the output of a decision operator to which said channel distortion-compensated output signal is coupled, said decision operator being operative to produce an output data stream in accordance with prescribed decision criteria applied to said channel distortion-compensated output signal,
an undistorted version of a known signal pattern contained in said communication signal, and
prescribed statistics or other quantities of one or more system signals.

11. The receiver apparatus according to claim 10, wherein said parameter estimate update mechanism is operative to update estimates of parameters of said adjustable inverse distortion operator by processing said channel distortion-compensated output signal and the output of said decision operator.

12. The receiver apparatus according to claim 11, wherein said parameter estimate update mechanism is operative to generate estimates of parameters of said adjustable inverse distortion operator by combining said channel distortion-compensated output signal and the output of said decision operator to produce an error signal and coupling said error signal to a parameter estimate generator for said adjustable inverse distortion operator.

13. The receiver apparatus according to claim 10, wherein said parameter estimate update mechanism is operative to update parameter estimates of said adjustable inverse distortion operator by processing said channel distortion-compensated output signal and an undistorted version of a known signal pattern contained in said communication signal.

14. The receiver apparatus according to claim 13, wherein said parameter estimate update mechanism is operative to update parameter estimates of adjustable inverse distortion operator by combining channel distortion-compensated output signal and an undistorted version of a known signal pattern contained in said communication signal to produce an error signal and coupling said error signal to a parameter estimate generator for said adjustable inverse distortion operator.

15. The receiver apparatus according to claim 10, wherein said known signal pattern comprises a frame synchronization pattern.

16. The receiver apparatus according to claim 15, wherein said frame synchronization pattern comprises sequences of synchronous optical network (SONET) frame synchronization fields.

17. The receiver apparatus according to claim 10, wherein said parameter estimate update mechanism is operative to update parameter values of said inverse distortion operator in accordance with said prescribed statistics or other quantities of one or more system signals.

18. The receiver apparatus according to claim 7, wherein said parameter estimate update mechanism is operative to update parameter values of said inverse distortion operator in accordance with prescribed statistics or other quantities of said electrical communication signal.

19. A method of processing a communication signal, that has been transported over a dispersive communication channel, so as to recover an unknown information signal contained in said communication signal, comprising the steps of:
(a) coupling said communication signal to an adjustable inverse distortion operator which is operative to subject said communication signal to a transfer function that is effectively or approximately complementary to a distortion-introducing characteristic of said dispersive communication channel to produce a channel distortion-compensated output signal;
(b) performing a decision operation on said channel distortion-compensated output signal produced by said adjustable inverse distortion operator to produce a decision signal representative of said information signal;
(c) updating estimates of parameters of said adjustable inverse distortion operator by performing a prescribed combination of said channel distortion-compensated output signal with at least one of:
said decision signal,
an undistorted version of a known signal pattern contained in said communication signal, and
prescribed statistics or other quantities of one or more system signals.

20. The method according to claim 19, wherein step (c) comprises updating estimates of parameters of said adjustable inverse distortion operator by differentially combining said channel distortion-compensated output signal and said decision signal.

21. The method according to claim 20, wherein step (c) comprises generating estimates of parameters of said adjustable inverse distortion operator by combining said channel distortion-compensated output signal and said decision signal, and coupling said error signal to a parameter estimate generator for said adjustable inverse distortion operator.

22. The method according to claim 19, wherein step (c) comprises updating estimates of parameters of said adjustable inverse distortion operator by processing said channel distortion-compensated output signal and an undistorted version of a known signal pattern contained in said communication signal.

23. The method according to claim 22, wherein step (c) comprises estimating and updating parameter values of said adjustable inverse distortion operator by combining said channel distortion-compensated output signal and an undistorted version of a known signal pattern contained in said communication signal to produce an error signal and coupling said error signal to a parameter estimator for said adjustable inverse distortion operator.

24. The method according to claim 19, wherein step (c) comprises subjecting said channel distortion-compensated output signal and said at least one of the output of said decision signal and said undistorted version of a known signal pattern contained in said communication signal to a prescribed synthesis operator to produce synthesized versions thereof, and processing said synthesized versions to estimate and update parameter values of said adjustable inverse distortion operator.

25. The method according to claim 15, wherein step (c) comprises updating parameter values of said inverse distortion operator in accordance with said prescribed statistics or other quantities of one or more system signals.

26. The method according to claim 25, wherein step (c) comprises updating parameter values of said inverse distortion operator in accordance with prescribed statistics or other quantities of said electrical communication signal.
